(19) United States
(12) Patent Application Publication
(10) Pub. No.: US 2022/0183200 A1
(43) Pub. Date: Jun. 16, 2022

(54) PLOUGH MODULE

(71) Applicant: Huber Soil Solution GmbH, Wagna (AT)

(72) Inventor: Franz-Ferdinand Huber, Leibnitz (AT)

(21) Appl. No.: 17/598,096

(22) PCT Filed: Mar. 24, 2020
(86) PCT No.: PCT/EP2020/058132

§ 371 Date: Sep. 24, 2021

(30) Foreign Application Priority Data
Mar. 27, 2019 (DE) 10 2019 204 256.2

(51) Int. Cl. A01B 9/00; A01B 13/08; A01B 15/16; A01B 49/02

(52) U.S. Cl. CPC A01B 9/003; A01B 49/025; A01B 15/16; A01B 13/08

(57) ABSTRACT

The invention relates to a plough module (1) for interchangeable mounting on a base frame (2) of a ploughing assembly (3) for ploughing ground, wherein the plough module (1) comprises: a rotatable first cutting element (102) which is designed as a coulter disc and has a rotating first cutting edge (103), wherein the first coulter element (102) is designed in such a manner that a lateral region (202) of a soil ridge (201) in the ground (120) can be cut by moving the plough module (1) on the ground (120) in a ploughing direction (110), a second, flat cutting element (105) having a second cutting edge (106), wherein the second cutting element (105) is designed in such a manner that a ground region (203) of a soil ridge (201) in the ground (120) can be cut by moving the plough module (1) on the ground (120) in a ploughing direction (110), characterized in that the plough module (1) is designed as a ready-mounted unit in which the second cutting element (105) in the ploughing direction (110) follows with its cutting edge the first cutting element (102), and with a first carrier structure (4), on which the first cutting element (102) is arranged, a second carrier structure (5), on which the second cutting element (105) is arranged and which is connected to the first carrier structure (4), and that the first carrier structure (4) has means for detachable attachment to a base frame (220) of a ploughing assembly (3).

### CROSS-REFERENCE TO RELATED APPLICATION

This is the United States national phase of International Patent Application No. PCT/EP2020/058132, filed Mar. 24, 2020, which claims priority to German Application No. 10 2019 204 256.2, filed Mar. 27, 2019, the entire contents of each of which are hereby incorporated herein by reference.

### FIELD OF THE DISCLOSURE

The present invention relates to a plow module for exchangeable installation on a base frame of a plow device for plowing ground, and a plow device which is equipped with at least one plow module of this type.

### BACKGROUND

During plowing with a plow device of this type, which is typically pulled by a tractor, so-called soil strips are cut out of the ground. A soil strip has a lateral region along which a first cutting element cuts or has cut. Furthermore, the soil strip has a bottom region which connects the two lateral regions and is separated from the ground by means of a second cutting element. Accordingly, the ground on the bottom region of the soil strip has a parting face (so-called plow sole). A roughly rectangular soil strip is thus cut out of the ground, wherein a horizontal cutting plane (=plow sole) is produced by means of the second cutting element, and a vertical cutting plane (=furrow wall) is produced by means of the first cutting element on the remaining ground. By cutting out the soil strip, a furrow wall is formed in the ground from which the lateral region of the soil strip would be detached. The bottom region thus defines the vertically bottommost face of the soil strip at the instant it is separated from the ground.

It is pointed out that the terms “horizontal” and “vertical” as well as “top” and “bottom” refer to arrangements and configurations of the plow devices and, thus, of the plow module according to the invention attached thereto, wherein the plow device, in accordance with the invention, is considered resting on the ground and during plowing operation movable along the processing direction.

In GB 1 385 951 a machine is described for removing surface layers in road construction or for the maintenance thereof. The machine described therein has two cutting elements, namely a hollow disc, which scrapes away a surface layer by corresponding rotation, while a flat disc coming after this cuts a lateral region. In this setup, the drive shaft arranged essentially in the direction perpendicular to the ground to be scraped away has a hollow configuration in order to introduce corresponding herbicides or other powdered, liquid or gaseous substances into the area to be processed. As long as the flat disc is removed from the device, it is also possible with respect to the hollow disc to work with other angles of the carrier axis. The flat disc is in this sense an add-on device, not a part of a module. The known machine is not suitable for plowing.

A relevant plow device is known from DE 10 2017 102 683 A1. A rotatable cutting element configured as a cutting plate and having a circumferential first cutting edge is arranged on the base frame of this plow device, wherein the first cutting element is configured such that a lateral region of a soil strip of the ground can be severed by moving the plow device on the ground along a plowing direction. The plowing direction or processing direction is defined as the direction along which the plow device is moved over the ground. A second, flat cutting element with a second cutting edge is likewise attached to the base frame and is arranged in front of the first cutting element in the plowing direction. The second cutting element is configured such that, by moving the plow module on the ground along a plowing direction, the bottom region of the soil strip can be severed. During plowing with this plow device, the bottom region of a soil strip to be formed is first severed by means of the second cutting element The subsequent first cutting element, which is configured as a crowned cutting plate, then cuts a lateral region of the soil strip and deposits it turned in the furrow that has been formed. A plow device of this type, in contrast to conventional plows with plow bodies and moldboards, requires substantially less tractive force.

A disadvantage of a plow device according to DE 10 2017 102 683 A1 is that the various cutting elements are individually mounted on the base frame, which makes installation or retrofitting on a conventional base frame for a plow difficult. In addition, the spatial orientation of the two cutting elements with respect to each other is complicated and their setting or adjustment is often possible only to a limited degree.

### GENERAL DESCRIPTION

The object of the invention is to provide an assembly which allows all functions of the plow or plowing method described at the outset and can be installed on a base frame of a plow device and which allows for easy-to-pull plowing.

This object is achieved by the plow module being configured as a fully assembled assembly and having a first carrier structure on which the first cutting element is arranged, and having a second carrier structure on which the second cutting element is arranged and which is joined to the first carrier structure, and by the first carrier structure having means for detachable attachment to a base frame of a plow device for which a plow module is provided in which the second cutting element is arranged after the first cutting element in the plowing direction.

In accordance with a first aspect of the present invention, the plow module for a plow device for plowing ground is described. The plow module has a first carrier structure on which a rotatable cutting element is arranged which is configured as a crowned disc. A second cutting element, e.g., a further disc, or a cutting knife, arranged at a defined angle relative to the first cutting element, is mounted on a second carrier structure, which is firmly connected on its part to the first carrier structure. The rotatable first cutting element has a circumferential first cutting edge and is configured in such a way that, when the plow device moves with the carrier structure on the ground along its plowing direction, i.e., of the processing direction, a lateral region of a soil strip of the ground, especially a furrow wall, is severed by means of a first cutting region of the first cutting edge. The first and second carrier structures are firmly joined to each other and are jointly arranged on the base structure of the plow device. The second cutting element has a second cutting edge, wherein the second cutting element is arranged on the second carrier structure and is configured in such a way that, when the plow module moves on the ground along the plowing direction, a bottom region of a soil strip of the ground, especially along a parting face between soil strip and plow sole, can be severed by means of a second cutting region of the second cutting edge. The second cutting element is arranged relative to the first cutting element in the plowing direction in such a way that the second cutting region is situated behind the first cutting region.

Preferably, the particular cutting elements on the plow module are adjustable, preferably pivotably, relative to each other with regard to their position. This represents a clear advantage over the known plow devices. Thus, a plowing module can be used, for example, in which the first cutting element for the lateral parting of the soil strip is arranged in front of the second cutting element for cutting the bottom of the soil strip.

Preferably, a plow device has a plurality of plow modules, for example, three to eight modules on a plow side, i.e., in relation to a base frame, together six to 16 modules. In contrast to the known plow devices, in which the first cutting element for cutting the side of the soil strip is arranged behind the second cutting element, which cuts the bottom of a soil strip or a furrow from which the soil strip is cut. This known arrangement has obviously been selected because the first cutting element in the cooperation, for example with a baffle plate or in an embodiment as a hollow disk, is responsible for turning the soil strip that has been cut out. To this end, the sole of a furrow, i.e., the bottom side of a soil strip, must already be cut. Therefore, in the known devices, the second cutting element is arranged with respect to its active blade in front of the first cutting element. This arrangement makes it possible to directly turn the first cutting element after its cutting of the sidewall of the soil strip because the plow sole has already been cut. In order for the first cutting element to reliably be able to cut the side or in a curved configuration also prepare the soil strip for turning and initiate the turning, the drive, or the mounting, or the bracket of the first cutting element must of course be provided on its back side. This means in turn, however, that the second cutting element the first cutting element must each have a separate carrier by means of which they are attached to the frame. For this reason, an adjustment of the two cutting elements to each other is made substantially more difficult.

By contrast, in the case of the present invention, the first cutting element, which cuts the side of the soil strip, is arranged in front of the second cutting element, which cuts the bottom face of the soil strip or the furrow. Normally, this is not taken into consideration because in a plow device in which the first cutting element for cutting the side of the soil strip is arranged first in the pulling direction, said plow device still cannot execute the function of the turning, even though the shape is configured as a hollow disc and is provided in principle for turning the soil strip. This is because the furrow bottom in fact was not yet cut. The advantage of the module according to the invention lies directly in the fact that only two cutting elements have to be provided without a deflection plate or moldboard being required. The advantage according to the invention then also consists in that, based on the fact that the first cutting element has the drive or the mount or the carrier structure on its back side and, in an arrangement in front of the second cutting element, which likewise has a carrier structure, the two carrier structures of the first cutting element and of the second cutting element can be connected to each other, so that a module is produced which can be attached to a single suspension on the carrier frame of the plow device. The decisive advantage is that a traditional plow device with plow bodies can be modified, and specifically without greater effort, by the plow bodies being removed and a corresponding module being installed. Obviously, the standard base frames, also called plow beams, can also be provided at the factory with the plow modules according to the present invention.

In a surprising way, it has been shown that, in the case of a plow device with a leading cutting element as a hollow disc, a cutting of the lateral region is possible without a turning first occurring because the furrow bottom has not yet been cut. The following second cutting element accomplishes this first. If in a plow device a plurality of such modules are arranged one behind the other, it has been shown that, even with the second module that follows the first module in the plowing direction, the first cutting element cuts not only the lateral region present there, but that the ground furrow is already cut there by the first module. In order for the second module to directly exert the configured function, namely that the first cutting element in the shape of a hollow disc cuts the lateral face of the soil strip and simultaneously can turn the soil strip.

With respect to the design, it is beneficial that the bracket or carrier structure of the first cutting element points rearward on the carrier structure for the second cutting element, so that there a slight attachment and connection of the two cutting elements to a module is possible. If the plow device, for example, has only one plow module, then in the very first plowing run during plowing of a field, only this very first run would be a run in which the side of the soil strip not yet cut free is cut, but a turning does not yet take place. However, already in the second run, a turning of the then laterally severed soil strip would then occur by means of the first cutting element, because the second cutting element would have already severed the plow sole there in the region and thus the lower face of the soil strip. This renders substantial advantages over the conventional plow devices. A replacement or conversion of conventional plow devices having plow bodies to the plow modules according to the invention is possible anyway. It is also easily possible, because of the modularity, to quickly replace defects or other plow modules on the plow device that have been adapted because of a modified ground structure.

The plow module according to the invention is especially advantageous if the first and second cutting elements are adjustable with respect to their positions. This renders an adjustability to the ground to be plowed as well as an adjustability of the two cutting elements to each other. The second cutting element can thus swivel on the carrier structure on which the first cutting element is attached in order to direct the inclination of the second cutting element slightly downward when the ground is cut into, in order to prevent this cutting element which cuts the furrow bottom from coming out during the plowing and simultaneously to keep the first cutting element in the ground. The first cutting element can be pivoted and displaced in a plurality of directions, and therefore has multiple degrees of freedom in order to realize a corresponding optimum plowing result in the cooperative working of the two cutting elements.

The provision of a plurality of modules on a plow device further has the advantage that a greater width can be plowed in a plowing run using the device according to the invention. An out-of-engagement pivoting of cutting elements is also useful if the edge of a field to be plowed is plowed and the width for the last plowing run would otherwise be so large that the danger would exist that a bottom is cut with the plow module arranged furthest to the side on, for example, a piece of ground which would possibly already be in the neighboring field. In order to prevent this, an out-of-engagement-pivoting of the corresponding cutting element or elements can prevent such a situation.

The plow module is coupled via the base structure of the plow device to a towing vehicle, such as a tractor, for example, which thus pulls the cutting elements along the plowing direction through the ground. The base structure can also be a part of an iron support or a plow beam. With the plow modules made of two cutting elements arranged on combined carrier structures, namely a first cutting element for cutting the side of a soil strip and for turning, and a second cutting element for cutting the plow sole, plow beams can also be completely dispensed with. The carrier structure has metal bars and/or composite fiber elements. Furthermore, as described in detail below, the attached element can be adjustably fastened to the carrier structure.

The plow beam or the carrier frame which is formed from the first and second carrier structures thus offers a rigid, yet suitable for adjustment, attachment structure for the cutting elements on the plow modules as well as for additional components, such as hinges or adjusting elements. In other words, the cutting elements are affixed to the particular first or second carrier structure in such a way that no relative motion between the cutting elements is possible during the plowing. If during plowing the second cutting element presses into the ground because of the cutting of the soil strip, then the first cutting element is simultaneously pressed into the ground by means of a drawing in force. However, the cutting elements can preferably also be adjustable during the plowing, which can be done electrically or hydraulically.

According to an exemplary embodiment, the first and/or the second cutting element(s) is/are pivotably mounted, for example by means of a hinge, to the particular carrier structure, so that the angle between the axis of rotation and the extension direction of the second cutting edge can be adjusted and fixed in a desired position. In a further advantageous embodiment of the invention, the second carrier structure is itself pivotably connected via a hinge to the second carrier structure. In this way the engagement angle of the second cutting element is adjustable in relation to the plowing direction. The engagement angle is thus typically such that the leading cutting edge is easily directed downward into the soil.

In a further exemplary embodiment, the first cutting element and/or the second cutting element is/are displaceably arranged in a swiveling and/or translatory manner on the particular carrier structure in order to adjust the engagement angle and the positions relative to each other. An engagement angle of the second cutting element in relation to the plowing direction can therefore be set depending on the ground conditions and depending on the desired processing depth.

A device, such as the above-described hinge, serves for the adjustment of the cutting element angle (plate-disc angle) and allows the adjustment of the cutting element inclination angle (vertical inclination relative to the furrow wall of the ground) and of the cutting element direction angle (relative to the plowing direction, i.e., to the tractor direction of travel). The cutting line of the cutting element between the first cutting edge and the furrow wall can be adjusted in height by means of an adjustable brace. Accordingly, the vertical and/or horizontal distance between the first cutting element and the second cutting element can be variably adjusted. In other words, in a further exemplary embodiment the first cutting element and the second cutting element can be arranged in relation to each other in such a way that the cutting region of the first cutting edge of the first cutting element is set at a vertical distance from the first cutting edge of the second cutting element. By means of an adjustment in the horizontal direction, the cutting width or plowing width of a plowing run is adjustable.

In executing the invention, it is preferred that the first cutting region is formed within a first cutting plane and the second cutting region is formed in a second cutting plane, wherein the first cutting plane and the second cutting plane create an angle in relation to each other of 30° to 135°, in particular 45° to 110°. The adjustment of the desired angle can be accomplished for this purpose by the two cutting elements each being pivot-mounted on the associated carrier structure. Obviously, a predefined fixed orientation of the two cutting planes is also within the scope of the invention.

The first cutting edge runs in a first cutting plane while the second cutting edge runs in a second cutting plane. The first cutting element and the second cutting element are thus attached relative to each other on the carrier structure in such a way that the first cutting plane and the second cutting plane are not configured parallel and have an angle relative to each other (opening angle) of, in particular, more or less than 90°. In other words, in a further exemplary embodiment, the first cutting element can be arranged in such a way that there is an angle of roughly 0° to roughly ±30° between the axis of rotation of the first cutting element and an extension direction of the second cutting edge (or a tangent on the second cutting region, if a rotating disc forms the second cutting element). In particular, the normal of the first cutting plane has a (directional) component which is parallel to a horizontal direction if the plow device rests on the ground as per intended use. The axis of rotation of the cutting element is in particular parallel to the normal of the first cutting plane. Furthermore, the normal of the second cutting plane has a further (directional) component which is parallel to a vertical direction if the plow device rests on the ground as per intended use. An angle between the normals of between 45° and 130° can be selected, for example, in order to achieve a desired furrow profile in the ground.

If the first cutting plane and the second cutting plane have an angle of approximately 90° to each other, the second cutting element presses the undercut soil strip in the direction of the first cutting element. This makes it so that the soil strip between the first cutting element and the second cutting element can advantageously be processed during the movement in the plowing direction. The cooperation of the two rotating machine elements, i.e., the first and second cutting element, provides a preferred plowing result or a “crumbling” (furrow slice fragmentation). Moreover, the strong lateral run of the first cutting element, which has a negative effect on the tractor travel line, is extensively compensated by the counteraction of the second cutting element. The towing vehicle thus remains in the track without a great amount of countersteering.

The first cutting element is rotatably mounted on the first carrier structure. Correspondingly, the first cutting element turns a first axis of rotation about which the first cutting element is turning. The first cutting element is preferably configured as a crowned cutting plate and has a circular perimeter line. The circumferential first cutting edge is configured along the perimeter line. By means of the first cutting edge, the lateral region of the soil strip is separated from the furrow wall of the ground and the soil strip is likewise laterally discharged. The circumferential first cutting edge has a first cutting region. The first cutting region is that perimeter cut of the first cutting edge which in the plowing direction is the first to come into contact with the ground and cuts it. The first cutting element can have a diameter of approximately 500 mm to approximately 800 mm. Furthermore, the first cutting element can have a set of teeth that is centrally mounted and can be adjustable in position with respect to the first carrier structure and the second cutting element, preferably by means of a carriage.

It is of particular advantage if the first cutting element, which is rotatable about an axis of rotation, is crowned or has a conical shape or truncated-cone shape. This ensures that the severed soil strip is turned and deposited in the adjacent furrow created during a previously occurring cycle of a plow module. The axis of rotation of the first cutting element is set here at an angle to the plowing direction in such a manner that the leading edge of the cutting element is lowered in relation to the plowing direction, and the cutting element extends essentially diagonally to the plowing direction and thus to the soil strip that it is to cut.

The first cutting element is automatically rotated when the plow device moves along the ground. Frictional forces cause the first cutting element to be moved. The first cutting element is preferably dimensioned in such a way that during the plowing only the bottom half of the first cutting element, which is located under the first axis of rotation, penetrates into the ground, so that frictional forces with the ground can induce the rotation.

The rotation of the crowned or plate-like first cutting element further causes the severed soil strip to be raised and at the same time discharged to the side. The severed soil strip is in particular in frictional contact with a first cutting face of the first cutting element. The first cutting face is that face of the first cutting element which is formed within the first cutting edge. Furthermore, the first cutting face is that face which is directed to the severed soil strip. The first cutting face can be homogeneously configured without recesses or raised points. Furthermore, the first cutting face (i.e., the outer face of the first cutting element) can form a conical shape or a truncated-cone shape.

In a preferred embodiment, the second cutting element is configured as a round disc and is rotatably mounted, wherein the second cutting edge is defined by the circumferential edge of the second cutting element. Alternatively, the second cutting element can be realized by an adjustable cutting knife with a cutting edge that extends transversely to the plowing direction. The cutting element, which preferably has toothing on its blade, is preferably at a defined angle to the plowing direction with its point directed slightly rearward, i.e., it has an angle of greater than 90° to the plowing direction. By means of the second cutting edge, the bottom region of the soil strip is separated from the plow sole of the ground, undercut and likewise raised where appropriate. In the case of a rotatable disc, the circumferential second cutting edge has a second cutting region. The second cutting region is that peripheral portion of the second cutting edge which comes into contact with the ground second in the plowing direction and cuts it.

The first cutting element, e.g., a crowned disc, severs the soil strip in a first, vertical cutting plane, for example at a processing depth coming out approximately 15 to 35 cm from the surface of the ground and guides the soil strip into a previously formed furrow.

In the second horizontal cutting plane, which is coming out in the processing depth approximately 15 to 35 cm from the surface of the ground, the soil strip is cut by the second cutting element horizontally, i.e., from the plow sole.

The distance of the two cutting planes (top: rotating first vertical cutting element; and bottom: second horizontal cutting element) can be adapted by an adjustment option of the rotating cutting element.

The effective plow body, consisting of the main components of the initial crowned cutting element and second flat cutting element, such as a cutting knife or rotatable disc, roughly corresponds to an oblique, serpentine plane which is pulled through the ground. The severed soil strip is displaced high and to the side along the crowned first cutting element on its inner side. This process includes a compression of the top half of the soil strip and an elongation of the lower half. As a consequence, compressive, tensile and torsional stresses that effect the fragmentation of the ground are produced inside the soil strip.

With the arrangement according to the invention of the second cutting element behind the first cutting element in the plowing direction, the frictional force, which otherwise would necessitate a high tractive force of the plow device, can be reduced. Because the soil strip, when it is cut from the first cutting element on its side, is already separated from the plow sole by the second cutting element, the soil strip is already raised and turned by the first cutting element. The second cutting region is, for example, between 1 cm and 50 cm, in particular 15 cm to 25 cm, behind the first cutting region in the plowing direction. The essentially horizontal second cutting disk or the cutting knife is the second to come into contact with the ground and runs, so to speak, after or following the essentially vertically arranged first cutting disk or the cutting element. This arrangement of the second cutting element horizontally “undercuts” the furrow wall or the soil strip to be plowed and thereby substantially facilitates the cleavage/furrow clearance. The vertically arranged crowned first cutting element vertically severs the soil strip that is horizontally precut by means of the trailing second cutting element in the subsequent plowing run and turns it by the rotational movement of the hollow disc and deposits it to the side, preferably in the furrow.

The plowing device thereby allows an easy-to-pull plowing effect. The friction coefficient is substantially reduced compared to traditional rigid plow bodies, because the cutting element co-rotates. This concept provides an easy-to-pull, fuel-saving plow, which at the same time produces a nearly seedbed-ready constant furrow profile.

According to a further exemplary embodiment, the second cutting element is an actively rotatable cutting element and the second cutting edge is a cutting edge running around the second cutting element. The second cutting element can thus be driven or rotated by means of an electric or hydraulic drive device.

According to a further exemplary embodiment, the first or second cutting edge of the first or second cutting element, respectively, is crowned with toothing and configured, for example, as a concave disc. A crowned design means that recesses or raised points (teeth) can be formed in the first or second cutting edge. This allows an improved cutting action of the first or second cutting element when the soil strip is severed. By means of the spherical cap design, in particular of the first cutting element, the soil strip that slides along it can undergo a turn, so that the attachment of a moldboard or deflector plate can be dispensed with. It is advantageous if the first cutting edge of the first cutting element and/or the second cutting edge of the second, disc-shaped cutting element has/have recesses on the circumference. This yields a design in the manner of a circular saw blade, which penetrates the soil especially easily and can be moved by engagement with the soil.

By means of the described plow device, pulling force/fuel can be spared due to the plow device being easy to pull. Furthermore, the plow device is universally usable and operates under nearly all soil conditions. Moreover, the soil strip is continuously broken by the rotational movement of the cutting plate. This achieves the desired crumbling of the furrow slice (furrow slice fragmentation). Due to the furrow slice fragmentation effect, the post-processing runs can be reduced. This saves on work cycles up to seed bed processing. Moreover, the soil is advantageously intermixed. Furthermore, conventional standard components or standard additional implements, such as skimmers and disc coulters, are no longer necessary. The rotating first and/or second cutting element produces less wear and therefore lower replacement part costs. This gentle ground processing prevents to the greatest possible extent humus-damaging metal abrasion from the cutting elements compared to a plow device with a traditional moldboard.

In accordance with a further exemplary embodiment, the plow device has a further plow module with likewise a rotatable first cutting element with a circumferential further first cutting edge and is configured in such a way that, when the carrier structure moves on the ground along the plowing direction, a further lateral region of a further soil strip can be severed from the ground by means of the further plow module and the further first cutting element is rotatable, so that the further soil strip can be raised by means of the further first cutting element.

The embodiment described above makes clear that a multiplicity of plow modules can be spaced apart next to each other in the plowing direction, i.e., along a direction orthogonal (in a horizontal plane) to the plowing direction and can be arranged next to each other. Therefore, a multiplicity of soil strips arranged next to each other in the plowing direction can be cut from the ground, raised and in some cases turned.

In the arrangement of a multitude or multiplicity of corresponding plow modules and, thus, a corresponding number of cutting elements in the plowing direction in succession, a wider area can be plowed in a plowing run, because of the lateral offset of the individual plow modules with respect to each other transverse to the plowing direction, than is the case if only a single plowing module is used in a plowing run. It is in turn advantageous for the functionality of the plow device if cutting elements are out of engagement and thus can be pivoted out of their set position. Consequently, it is possible, for example, to make a leading cutting element from a trailing one. Advantageously, this can be useful or advantageous in combination with a plurality of plow modules of a plow device for various parameters, such as ground conditions, also, for example, for the purposes of optimum adaptation.

The plow device according to the invention allows a gentle and even turning of the soil strip of the ground to, for example, 15 centimeters with, for example, the upper rotatable crowned first cutting element, even without a deflector plate and without a moldboard.

In an exemplary embodiment, the first cutting element and the second cutting element are arranged (e.g., by means of screw connections) on the relevant carrier structure so as to be exchangeable. The first carrier structure is configured here in such a manner that they can be installed on the base frame of the plow device in a detachable manner, preferably by screw connections. Shear pins can also be provided for stone protection. The mounting elements provided for this purpose, such as boreholes or pins, are preferably provided and arranged in such a manner that they are compatible with standard commercially available base frames for plow devices. Therefore, the plow module can easily be retrofitted on the base structure of a plow device in place, for example, of a plow body.

Based on the rotation of the first cutting element, the severed soil strip is easily raised, turned and discharged onto the furrow. When the plow device moves along the plowing direction, the soil strip is turned in the plowing direction.

Based on the raising of the soil strip by means of the rotating first cutting element, the soil strip can be discharged behind the cutting element in the plowing direction in an energy efficient manner.

In an especially preferred embodiment of the plow module according to the invention, the second cutting element is configured as a stationary cutting knife. The cutting knife is configured here as a flat, rectangular, straight or curved blade which is fastened at an end region to the second carrier structure. The attachment is accomplished by screw connection, which also allows for an easy exchange of the second cutting element when it is worn out. The cutting edge of the blade in its working position points in the plowing direction and is generally oriented transverse to this direction.

In an advantageous modification of this design, the cutting knife of the second cutting element has an L-shaped design, wherein a first bar of the cutting knife is horizontally aligned in the working position of the plow module and a second bar is aligned essentially perpendicular thereto. The first bar therefore cuts the bottom region of the soil strip to be formed. Meanwhile, the second bar, which is vertical in the working position of the plow module, is situated in front of the first cutting element and facilitates its penetration into the ground, because it essentially runs in the same plane as the leading edge of the first cutting element. Already for reasons of mechanical robustness, it is expedient for the cutting knife to have a one-piece design. It generally has the shape of a flat blade, which has a sharpened blade on the front side. The engagement angle of the blade can be adjustable in relation to the plowing direction in order to ensure that a desired penetration depth of the plowing module into the ground is reached and maintained.

The invention also comprises a plow device on the base frame of which at least one plow module according to the invention is arranged; preferably six to 16 plow modules of this type are arranged thereon. The plow module is preferably firmly connected here via screw connections to the base frame, wherein the connection is made via the first carrier structure. It is understood that compatible fastener elements, such as boreholes or threaded studs, must be formed on the base frame and on the first carrier structure. Alternatively, an adapter element can also be provided in order to be able to adapt and secure the plow module to various base frames of plows. Thus, the plow module can in a simple manner be mounted on a base frame or removed for maintenance purposes.

### BRIEF DESCRIPTION OF THE DRAWINGS

In the following, exemplary embodiments are more closely described with reference to the accompanying drawings for further clarification and for better understanding of the present invention. Shown are:

FIG. 1 a representation of a plow module according to an exemplary embodiment of the invention;

FIG. 2 a schematic representation of a plow device according to an exemplary embodiment of the present invention during a plowing operation;

FIG. 3 a plow module according to a further exemplary embodiment of the invention, in which module the alternative arrangement of a cutting knife and a cutting disc is shown as a second cutting element;

FIG. 4 a representation of a plow device according to the invention as a conventional plow device having three plow modules in a further exemplary embodiment of the invention and

FIG. 5 a top view of a plow device in which, for example, a plow body is replaced by a plow module configured for retrofitting.

### DETAILED DESCRIPTION

Identical or similar components in different figures are provided with the same reference numbers. The representations in the figures are largely schematic and serve only as examples.

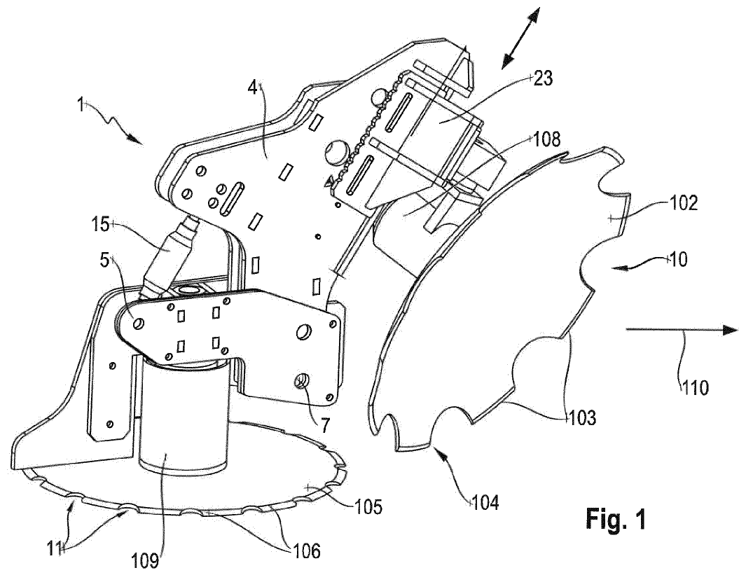

FIG. 1 shows a plow module for plowing ground 120, in which plow module a first cutting element 102 in the shape of a spherical-cap-type hollow disc in front of a second cutting element 105 in the form of a flat plate are arranged one behind the other in the plowing direction. The first cutting element 102 is provided for cutting the lateral face of a soil strip, whereas the second cutting element 105 arranged after the first cutting element 102 is configured as a flat disc which cuts the furrow bottom. Both cutting elements 102, 105 are combined by means of a support structure 4, 5 as a plowing module. The support structure 4, 5 can be secured to a base frame (not shown), wherein the second cutting element 105 has an articulated connection to the first cutting element 102 via its carrier structure 4.

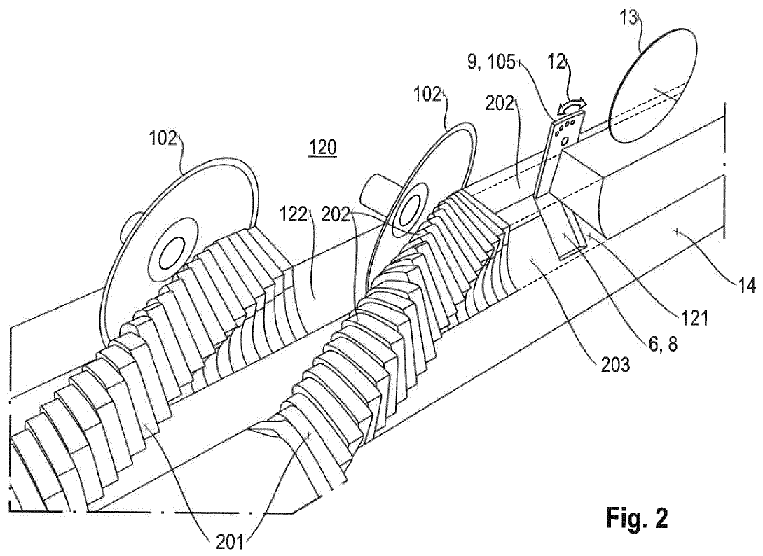

As shown in FIG. 1, a rotatable first cutting element 102 having a circumferential crowned first cutting edge 103 is arranged on a first carrier structure 4 and is configured in such a way that, when the carrier structure 4 is moved on the ground 120 along the plowing direction 110, a lateral region 202 (see FIG. 2) of a soil strip 201 of the ground 120 can be cut by means of a first cutting region of the first cutting edge 103, as is shown in FIG. 2. The plowing direction 110 is defined as the direction along which the plowing direction 3 is moved over the ground 120. A second cutting element 105 having a second cutting edge 106 is arranged on a second carrier structure 5, which is releasably connected to the first carrier structure 4 and can be pivoted in relation to the first carrier structure. The second cutting element 105 is configured in such a way that, when the carrier structure moves 5 on the ground 120 along the plowing direction 110, a bottom region 203 of a soil strip 201 of the ground 120 can be severed by means of a second cutting region of the second cutting edge 106, wherein the second cutting element 105 is arranged relative to the first cutting element 102 in plowing direction 110 in such a way that the second cutting region is arranged after the first cutting region in the plowing direction. The second cutting region is thus set apart from the first cutting region at the distance x.

Because during plowing the base frame 2 of the plow module 1 is pressed with the first and second carrier structures 4 and 5 in the direction of parting face 121 of the ground 120, the first cutting element 102 is also pressed accordingly in the direction of a parting face 121, so that the first cutting element 102 is kept at the desired ground depth during the plowing.

FIG. 2 shows a schematic representation of the essential functional elements of a plow device according to an exemplary embodiment of the present invention during a plowing operation. This FIG. 2 shows the correct spatial arrangement of the first and second cutting elements 102 and 105 as well as the formation and turning of soil strips 201. For the sake of greater clarity, the remaining components of the associated plow device 3 are not depicted.

As shown in FIG. 2, so-called soil strips 201 are cut out of the ground 120 during the plowing. A soil strip 201 has a lateral region 202 along which the first cutting element 102 cuts. Furthermore, the soil strip 201 has a bottom region 203, which connects the two lateral regions 202 and is separated by means of the second cutting element 105, which is depicted here, for example, as a stationary cutting knife 6 in a double-L shape. Accordingly, the ground 120 at the bottom region 203 of the soil strip 201 has a parting face 121, the so-called plow sole 121. After the soil strip 201 is cut out, the furrow wall 122 from which the lateral region 202 of the soil strip 201 was released is recognizable in the ground 120. The bottom region 203 thus defines the bottommost horizontal face in the vertical direction of the soil strip 201 at the instant of separation from the ground 120. The lateral regions 202 of the soil strip 201 define the lateral wall regions of the soil strip 201 at the instant of separation from the ground 120.

As shown in FIG. 1, the carrier structures 4 and 5 for the two cutting elements 102 and 105 are formed in such a way that together they jointly connect at least the first cutting element 102 and the second cutting element 105 to the base frame 2 of a plow device 3. The first carrier structure 4 can be attached via the base frame 2 of the plow device 3 to a towing vehicle, such as a tractor, in order to thereby drive the cutting elements 102, 105 along the plowing direction 110 accordingly. The plowing module 1 has, for example, the first and second carrier structure 4, 5, which can be configured as rigid or pivoting via hinges.

The first and second carrier structures 4 and 5 thus form a rigid attachment structure for the cutting elements 102, 105. The cutting elements 102, 105 are fixed to the carrier structures 4, 5 in such a way that no relative movement between the positions of the cutting elements 102, 105 is possible during the plowing. Therefore, if the second cutting element 105 is pressed in the direction of the ground 120 because of the cutting of the soil strip 201 in accordance with the invention, also the first cutting element 102 is simultaneously pressed into the ground 120, because both carrier structures 4, 5 are fixedly connected to each other.

The first cutting element 102 and the second cutting element 105 are rotatably attached to the relevant carrier structure 4 or 5. Accordingly, the first cutting element 102 has an axis of rotation 108 about which the cutting element 102 rotates. The second cutting element 105 forms a second axis of rotation 109 about which the second cutting element 105 rotates. The first cutting element 102 and the second cutting element 105 are formed here, for example, as cutting plates with a spherical cap design or as a flat disc and have a circular perimeter line. The corresponding circumferential first cutting edge 103 and the second cutting edge 106 are formed along the perimeter line. By means of the first cutting edge 103, the lateral region 202 of the soil strip 201 is separated from the furrow wall 122 of the ground 120. The circumferential first cutting edge 103 has a cutting region 104. The cutting region 104 is that circumferential portion of the first cutting edge 103 which in the plowing direction 110 is the first to come into contact with the ground 120 and cut it. By means of the second cutting edge 106, a bottom region 203 of the soil strip 201 is separated from the ground 120. The second cutting region of the second cutting edge 106 is that circumferential portion of the second cutting element 105 which in the plowing direction 110 is the second to make contact with the ground 120 or follows the first cutting element and cuts said ground. The double arrow 12 in FIG. 2 indicates that the second cutting element 105 is pivot mounted on the second carrier structure 5 (not shown). The swiveling allows the setting of the engagement angle of the cutting knife 6 in relation to the plowing direction and thus the penetration depth of the plow module 1 into the ground 120.

A rotatable disc coulter 13 can be arranged in front of the plow module 1 or connected thereto and pre-cuts or opens the ground 120 in front of the vertical, second bar 9 of the cutting knife 6 and the first cutting element 102. In this way, the tractive force required for the plowing is reduced, as is the wear of the cutting knife 6 and the trailing first cutting element 102. The cutting knife cuts horizontally and vertically as a double or triple cutting blade.

The first cutting element 102 is rotated if the plowing device 3 moves along the ground 120. Frictional forces, for example, cause the cutting element 102 to move. The cutting element 102 is thus dimensioned such that, during the plowing only the bottom half of the first cutting element 102, which is located below the axis of rotation 108, penetrates into the ground 120 so that frictional forces with the ground 120 induce the rotation.

The rotation of the first cutting element 102 further causes the severed soil strip 201 to be raised. This is indicated in FIG. 2 with the arrows, which depict the conveying direction 123 of the soil strip 201 along the plow device 3.

The severed soil strip 201 is in frictional contact with a cutting face 113 of the cutting element 102. The cutting face 113 is that face of the cutting element 102 which is configured inside the first cutting edge 103 and surrounded thereby. Furthermore, the cutting face 113 is that face which is directed toward the severed soil strip 201. The cutting face 113 can, as depicted in FIG. 1, have a homogeneous design without recesses or raised points.

Because of the raising of the soil strip 201 by means of the rotating cutting element 102, the soil strip 201 can be conveyed into the adjacent furrow in an energy-efficient manner. This furrow was raised during a preceding cycle of the plow module, as depicted in FIG. 2.

According to FIG. 1, the first cutting element 102 and the second cutting element 105 are attached on the carrier structure 4, 5 relative to each other in such a way that the cutting region 104 of the first cutting element 102 is set at a distance in the vertical direction from the second cutting element 105, or is situated over the second cutting element 105 if the plow device 3 in the working position rests on the ground 120 or penetrates into the ground.

The rotating cutting element 102 and the second cutting element 105 cooperate synergistically. On the one hand, a desired plowing depth is kept constant by means of the second cutting element 105, because the severed soil strips 201 press with a defined compressive force/drawing in force on the second cutting element 105 and thereby counteract a lifting of the rotating cutting element 102. On the other hand, the energy-promoting action of the rotating cutting element 102 is utilized during the cutting of the soil strip 201, in particular of the lateral faces or lateral regions 202 of the soil strip 201. Thus, an energy-efficient plow device 3 is provided without negatively affecting the quality of the furrow profile. Moreover, the rotating second cutting element 105 causes the severed soil strip 201 to be pressed toward the first cutting element 102, so that a crumbling of the severed soil strip 201 is carried out. Furthermore, because of a lateral force which is inserted by means of the forwardly positioned second cutting element 105 into the first carrier structure 4, it is that a lateral force induced during the cutting on the first cutting element 102 is counteracted, thereby allowing an easier and better guidance of the plow device 3 with a towing vehicle.

The first cutting element 102 and the second cutting element 105 are arranged in relation to each other in such a way on the first and second carrier structures 4 and 5 that the second cutting region 107 of the second cutting edge 106 of the second cutting element 105, which second region comprises the front half of the cutting element 105, is situated with a distance x in the plowing direction 110 after the first cutting region 104 of the first cutting edge 103 of the first cutting element 102. Therefore, the rotating first cutting element 105 first hits the soil strip 201 laterally during the plowing and severs it from the remaining ground 120 in an energy-efficient manner with the second cutting edge 106 of the second cutting element 105. Then the first cutting element 105 uses the first cutting edge 103 to cut a lateral region 202 of a soil strip 201. The second cutting element 105 thus separates the furrow wall cut with the first cutting element 102. As a result, the trailing cutting element 102 of the trailing module can vertically cut the soil strip on the side and turn it. Then the soil strip 201 is turned by the curved shape of the first cutting element 102 and its diagonal orientation with respect to the plowing direction and deposited in the adjacent furrow. Thus, the first cutting element 102 and the second cutting element 105 cut into the soil strip 201, and they are simultaneously held at the desired cutting depth with the compressive force acting on the second cutting element 105.

The second cutting element 105 undercuts the soil strip 201 with a region (approx. half a circular disc). A further attachment region of the second cutting element 105, on which a mounting rod/shaft (axis of rotation 109) is arranged for attachment to the first carrier structure 4, is configured on the side of the second cutting element 105 that faces away from the first cutting element 102. Thus, the mounting rod/shaft runs in an already processed furrow during the plowing, thereby reducing the tractive force of the plow device 3.

The carrier structure 4, 5 is configured in such a way that the first cutting element 102 and/or the second cutting element 105 are adjustable relative to each other along the plowing direction 110 and/or perpendicularly, i.e., vertically, to the plowing direction 110. For example, the first cutting element 102 can be displaceably fastened on the carrier structure 4 by means of bolted connections 115, which can engage in elongated holes 116 of the first carrier structure 4. By means of adjusting the distances of the cutting element 102, the second cutting element 105 and the carrier structure 4, 5 along the plowing direction 110, the plowing device 3 can be adjusted to special conditions of different types of soil and used in a manner optimized for efficiency. Furthermore, the elements can be readjusted if the elements lose their shape after the plow device 2 is used.

Furthermore, the carrier structure 4, 5 can be configured in such a way that the first cutting element 102 along a directional component of the first axis of rotation 108 and the second cutting element 105 along a directional component of the second axis of rotation 109 are adjustable relative to each other. In particular, an angle can be set between the first axis of rotation 108 and the second axis of rotation 109. The first cutting edge 103 runs in a first cutting plane while the second cutting edge 106 runs in a second cutting plane. The first cutting element 102 and the second cutting element 105 are thus attached relative to each other on the particular carrier structure 4 or 5 in such a way that the first cutting plane and the second cutting plane are not configured parallel and have an angle with respect to each other. For example, an angle between the first axis of rotation 108 and the second axis of rotation 109 is less than 90°, in particular between 45° and 80°.

Accordingly, a distance between the cutting region 104 of the first cutting edge 103 of the cutting element 102 and the second cutting edge 106 of the second cutting element 105 can be set with the flexible attachment of the cutting element 102 and/or the second cutting element 105 to the carrier structures 4 and 5.

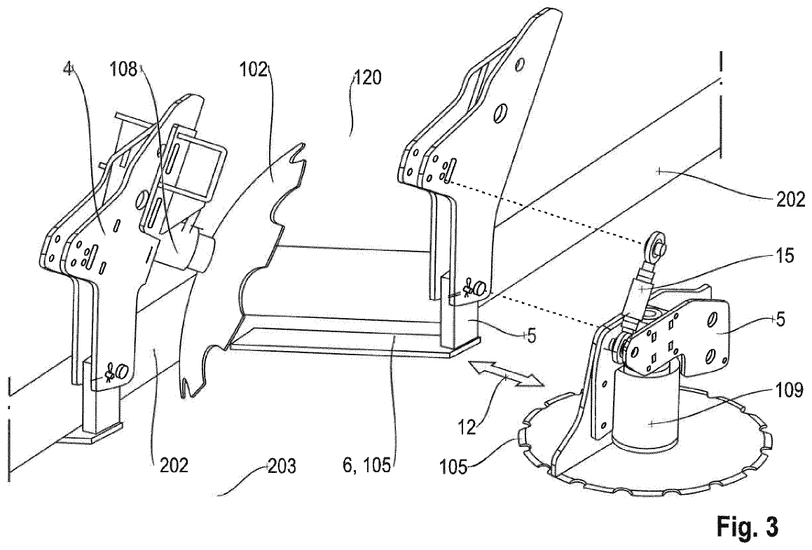

FIG. 3 shows a plow module 1 according to an exemplary embodiment of the present invention in which the second cutting element 105 is alternatively configured as a rotating disk 16 or as a stationary cutting knife 6.

The first cutting element 102 and/or the second cutting element 105 can be pivotably mounted, for example by means of a hinge, on a particular carrier structure 4 or 5, so that an angle can be set between the first axis of rotation 108 and the second axis of rotation 109 and fixed in a desired position. This possibility is indicated here by a hydraulic cylinder or a spindle 15, which connects the second cutting element 105, which is pivotably mounted in the second carrier structure 5, to the first carrier structure 4. The position of the first cutting element 102, which is shown here by way of example as a concave disc with a crowned edge, can also be adjusted, for example hydraulically, in relation to the first carrier structure 4. Such an adjustment can influence, among other things, the width of the formed furrow 14 or the interaction of the two cutting elements 102 and 105.

The first cutting element 102 in FIG. 3 has a spherical cap design and a corresponding mounting region on its first axis of rotation 108, which region is configured in a mounting plane. The circumferential first cutting edge 103 runs inside the first cutting plane, wherein the mounting plane is set at a distance from the cutting plane along the axis of rotation 108. The cutting face 113 of the cutting element 102 is configured between the circumferential first cutting edge 103 and the mounting region.

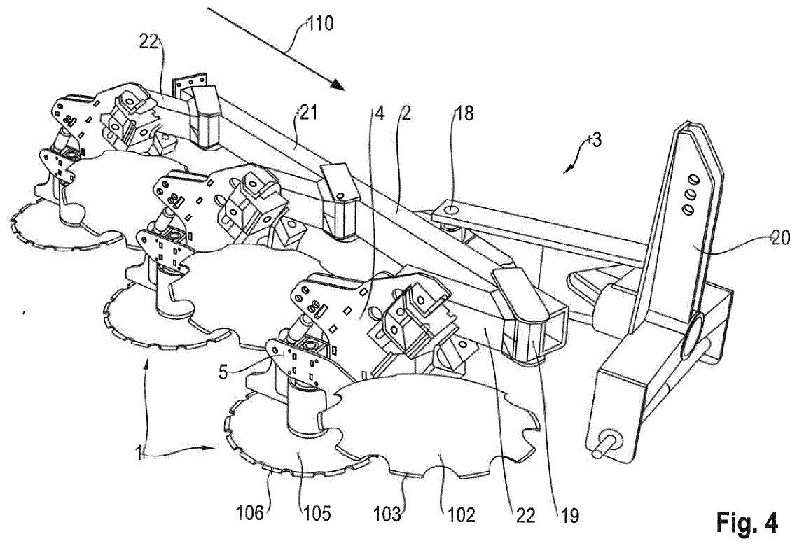

FIG. 4 is an illustration with a plow device 3 according to the invention as a conventional plow device on the base frame 2 of which three plow modules 1 according to the invention are shown by way of example. Each of the three plow modules shown has a first cutting element 102 and a second cutting element 105 that trails the first, each of which is connected to each other at a first carrier structure 4 and a second carrier structure 5 to form a unified plow module, wherein the second carrier structure 5 is pivotably articulated on the first carrier structure, so that the second cutting element 105 can have an at least small engagement angle at the bottom in the soil in order to therefore exert the required pressure on the plow device, to remain at the desired plowing depth and thereby ensure the first cutting element 102 configured as a hollow disc at the desired depth for severing the side of the soil strip. During plowing in the plowing direction indicated with the arrow 110, the first cutting element 102 with the circumferential cutting edge 103 for cutting the side of the soil strip is in front of the second cutting element 105 with a likewise circumferential cutting edge 106 for cutting the furrow bottom. A first coupling part 20 is used to connect the plow device 3 to, for example, a towing vehicle, wherein the first coupling part 20 has an articulated connection to the generally bar-shaped second coupling part 21. The second coupling part 21 represents in principle the base frame 2. The plow modules 1 are fastened by means of hinges 19 to the base frame 2.

When pulled over the ground 120, a part of the plow modules penetrates into the soil 120 to a depth specified by design and ejects the soil strips 201 thus produced. The plow modules 1 are situated essentially staggered next to each other, so that a plurality of soil strips corresponding to their number are produced, as is shown in FIG. 2. These soil strips 201 after the turning come to rest in the furrow 14 formed by the preceding cutting elements 102 after they leave the first cutting element 102, as is shown in FIG. 2.

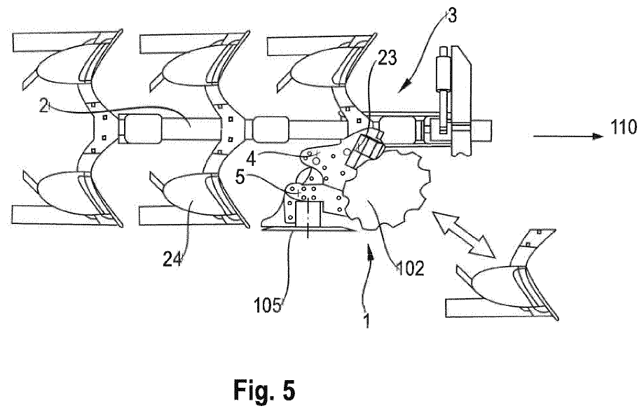

And finally, a plow device 3 is shown in FIG. 5 in a top view for which six plow bodies 24 are arranged next to each other in pairs. The double arrow shows that the plow bodies 24 can be replaced with the plow modules 1 according to the invention. This is especially easy with respect to the assembly effort, because the complete plow modules 1 are exchangeable for the plow bodies 24 originally installed on the plow device without the installation effort being significantly increased. The plow modules 1 according to the invention have a first, leading cutting element 102 for cutting the sides of the soil strip and a trailing cutting element 105 for cutting the furrow bottom. The second cutting element 105 is mounted on a carrier structure 5, whereas the first cutting element 102 is attached to a first carrier structure 4. The carrier structure 4 and the carrier structure 5 are connected to each other, and specifically such that the second carrier structure 5 is pivotable in order to be able to set the engagement angle of the second cutting element 105 with respect to the plow sole. The first cutting element 102 is adjustable in multiple degrees of freedom, so that adjustment is possible depending on the soil parameters and also with regard to further parameters by adjusting, on the one hand, the plowing width and, on the other hand, the interaction between the first cutting element 102 and the second cutting element 105. Therefore, the first cutting element 102, for example, is adjustable by means of a carriage 23 on the first carrier structure 4, so that its height is adjustable with respect to the plane which is intersected by the second cutting element 105.

1. A plow module (1) for replaceable installation on a base frame (3) of a plow device (2) for plowing ground, wherein the plow module (1) comprises:
a rotatable first cutting element (102) formed as a crowned cutting plate, having a circumferential first cutting edge (103), wherein the first cutting element (102) is formed in such a way that, by moving the plow module (1) on the ground (120) along a plowing direction (110), a lateral region (202) of a soil strip (201) of the ground (120) can be cut,
a second, flat cutting element (105) having a second cutting edge (106), wherein the second cutting element (105) is formed in such a way that by moving the plow module (1) on the ground (120) along the plowing direction (110) a bottom region (203) of the soil strip (201) of the ground (120) can be severed,
characterized in that
the plow module (1) is formed as a fully mounted assembly in which the second cutting element (105) with its cutting edge follows the first cutting element (102) in the plowing direction (110) and
a first carrier structure (4) is provided, on which the first cutting element (102) is arranged,
a second carrier structure (5) is provided, on which the cutting element (105) is arranged and which is connected to the first carrier structure (4),
the first carrier structure (4) has means for releasable attachment to a base frame (3) of the plow device (2).

2. The plow module according to claim 1, characterized in that the second carrier structure (5) is connected via a hinge (7) to the first carrier structure (4).

3. The plow module according to claim 1, characterized in that the first cutting element (102) is displaceably arranged on the first carrier structure (4) in such a manner that the distance between the first cutting edge (103) of the first cutting element (102) and the second cutting edge (106) of the second cutting element (105) is adjustable.

4. The plow module (1) according to claim 1, wherein the first cutting element (102) and second cutting element (105) are arranged in relation to one another in such a manner that the cutting region (104) of the first cutting edge (103) of the first cutting element (102) is vertically set at a distance from second cutting edge (106) of the second cutting element (105).

5. The plow module (1) according to claim 1, wherein the first cutting region (104) is formed within a first cutting plane and the second cutting region (118) within a second cutting plane, wherein the first cutting plane and the second cutting plane form an angle with each other from 30° to 135°, in particular from 45° to 110°.

6. The plow module (1) according to claim 1, wherein the crowned first cutting element (102) has a conical or truncated-cone design.

7. The plow module (1) according to claim 1, wherein the first cutting edge (103) of the first cutting element (102) and/or the second cutting edge (106) of the second, disc-shaped cutting element (105) has recesses (10, 11) on the perimeter.

8. The plow module (1) according to claim 1, wherein the second cutting element (105) is a rotatable cutting element and the second cutting edge (106) is a circumferential cutting edge (106).

9. The plow module (1) according to claim 1, wherein the second cutting element (105) is a stationary cutting knife (6).

10. The plow module according to claim 9, characterized in that the cutting knife (6) of the second cutting element (105) has an L-shaped design, wherein a first bar (8) of the cutting knife (6) is horizontally aligned in the working position of the plow module (1) and a second bar (9) is aligned essentially perpendicular thereto.

11. The plow module according to claim 10, characterized in that the cutting knife (6) has a one-piece design.

12. A plow device (2) comprising a base frame (3), characterized in that at least one plow module (1) according to claim 1 is arranged on the base frame (3) of the plow device (2).
